(19) United States
(12) Patent Application Publication
(10) Pub. No.: US 2015/0012155 A1
(43) Pub. Date: Jan. 8, 2015

(54) AIRCRAFT COMPRISING A MEASURING PROBE AND METHOD FOR DETERMINING FLIGHT PARAMETERS OF SUCH AN AIRCRAFT

(71) Applicant: THALES, Neuilly Sur Seine (FR)

(72) Inventor: Jacques MANDLE, Valence Cedex (FR)

(73) Assignee: THALES, Neuilly Sur Seine (FR)

(21) Appl. No.: 14/323,366

(22) Filed: Jul. 3, 2014

(30) Foreign Application Priority Data
Jul. 4, 2013 (FR) 13 01590

(51) Int. Cl. B64D 45/00; G01C 21/00

(52) U.S. Cl. CPC B64D 45/00; G01C 21/005
USPC 701/14

(57) ABSTRACT

The invention relates to an aircraft including a fuselage and a first measuring probe including means for measuring the local incidence, means for measuring the static pressure, and optionally means for measuring the total pressure. The fuselage includes at least one first zone where the pressure coefficient of the aircraft depends on the unique local incidence irrespective of the sideslip and incidence values of the aircraft, and the first measuring probe is arranged in said first zone

### CROSS-REFERENCE TO RELATED APPLICATIONS

The present application claims priority to French Application Serial Number 13 01590, filed Jul. 4, 2013. This application is herein incorporated by reference.

### FIELD OF THE INVENTION

The present invention relates to aircraft and measuring probes equipping those aircraft.

### BACKGROUND

More specifically, the invention relates to an aircraft including a fuselage and a first measuring probe comprising means for measuring the local incidence, means for measuring the static pressure, and optionally means for measuring the total pressure.

Such an aircraft is for example described in document EP 1,354,212 B1.

In a known manner, the piloting of an aircraft is based on the determination of flight parameters such as its altitude, its relative airspeed, called conventional speed, its incidence, its sideslip, and its Mach number.

These flight parameters are determined using measurements of the static pressure, the total pressure and the local incidence from which these flight parameters are determined.

One of the flight parameters in question is the upstream infinity static pressure of the aircraft, which, together with the total pressure, makes it possible to determine certain anemobarometric information of the so-called “basic T”, including the altitude of the aircraft and its calibrated airspeed (CAS). This upstream infinity static pressure of the aircraft is determined from the corrected local static pressure and the pressure coefficient of the aircraft. This pressure coefficient of the aircraft corresponds to the pressure disruption created by the airplane. The pressure coefficient of the aircraft also depends on the given local incidence for each value of the sideslip and for each value of the incidence of the aircraft.

However, the known aircraft are not fully satisfactory.

In fact, to determine the upstream infinity static pressure of the known aircraft, it is necessary to determine a value of the sideslip or a value of the incidence of the aircraft beforehand so as to determine the function that associates the pressure coefficient of the aircraft with the local incidence. This is done from several measurements of the local incidence or the static pressure, which in turn are done at separate locations of the aircraft. The upstream infinity static pressure of the aircraft then can only be determined for measurements provided by at least two measuring probes situated at different locations. This results in a significant complexity of the system for measuring flight parameters of the aircraft, as well as operating safety constraints for that system.

One of the aims of the invention is to propose an aircraft not having these drawbacks.

### SUMMARY

To that end, the invention relates to an aircraft as previously defined, wherein the fuselage includes at least one first zone where the pressure coefficient of the aircraft depends on the local incidence, which is unique, irrespective of the sideslip and incidence values of the aircraft, and wherein the first measuring probe is arranged in said first zone.

According to other aspects of the invention, the aircraft comprises one or more of the following technical features, considered alone or according to all technically possible combination(s) the aircraft includes a second measuring probe comprising secondary means for measuring the local incidence, secondary means for measuring the static pressure, and optionally secondary means for measuring the total pressure; the second measuring probe is arranged on the fuselage in a second zone symmetrical with the first zone relative to a vertical plane of symmetry of the aircraft; the means for measuring a static pressure and the means for measuring the total pressure of the or each measuring probe are immobile relative to the fuselage of the aircraft; and at least one measuring probe has a pressure coefficient verifying the relationship:

$$Kps = \frac{- Kpa}{( 1 - Kpa )} ,$$

where Kps is the pressure coefficient of said measuring probe and Kpa is the pressure coefficient of the aircraft.

The invention also relates to a method for determining flight parameters of an aircraft as defined above, including a measuring step during which at least one first measurement of the static pressure and one first measurement of the local incidence are done via the first measuring probe.

According to other aspects of the invention, the method has one or more of the following technical features, considered alone or according to any technically possible combination(s) the method further comprises a step for determining flight parameters during which at least one value of the upstream infinity static pressure of the aircraft is determined; during the step for determining flight parameters, the value of the pressure coefficient of the first measuring probe and the value of the pressure coefficient of the aircraft are determined from the first local incidence measurement; a measurement of the total pressure is also done during the measuring step, and during the step for determining flight parameters, a value of an independent static pressure associated with the first measuring probe is determined from the pressure coefficient of the first measuring probe, the first static pressure measurement and the total pressure measurement, and the value of the upstream infinity static pressure of the aircraft is determined from the pressure coefficient of the aircraft, the total pressure measurements and said independent static pressure; the upstream infinity static pressure of the aircraft is taken to be equal to the static pressure measured via the or one of the measuring probes whereof the pressure coefficient verifies the relationship:

$$Kps = \frac{- Kpa}{( 1 - Kpa )} ;$$

during the measuring step, a second measurement of the local incidence is also done via the second measuring probe, and during the step for determining flight parameters, a first value of the sideslip and a first value of the incidence of the aircraft are determined from first and second measurements of the local incidence; during the step for determining flight parameters, a second value of the sideslip of the aircraft is determined from the first measurement of the static pressure and a measurement of the static pressure done via the second measuring probe, a measurement of the total pressure and the value of the upstream infinity static pressure of the aircraft; and the method further includes a validation step, during which the first and second values of the sideslip of the aircraft are compared.

### BRIEF DESCRIPTION OF THE DRAWINGS

The invention will be better understood upon reading the following detailed description, provided solely as an example and done in reference to the appended Figures, in which:

FIG. 1 is a diagrammatic illustration of the aircraft;

FIG. 2 is a diagrammatic illustration of measuring probes of the aircraft of FIG. 1;

FIG. 3 is a diagrammatic illustration of a measuring probe according to an example;

FIG. 4 is a diagrammatic illustration of a measuring probe according to another example;

FIG. 5 is a curve illustrating the variation of the pressure coefficient of a measuring probe as a function of the incidence of the measuring probe;

FIG. 6 is a curve illustrating the variation of the pressure coefficient of the aircraft as a function of the local incidence;

FIG. 7 is a block diagram illustrating a method for determining flight parameters according to an example of the invention; and

FIG. 8 is a diagrammatic illustration of a measuring probe according to a further example of the aircraft according to the invention.

### DETAILED DESCRIPTION

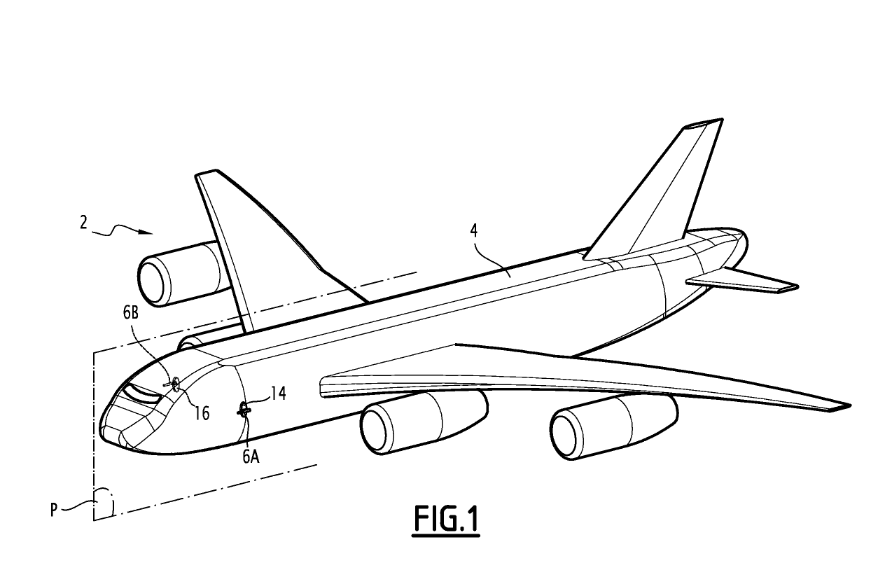

FIG. 1 illustrates an aircraft 2 according to the invention.

The aircraft 2 includes a fuselage 4. The fuselage 4 includes a substantially cylindrical central segment extended by a slender front nose and a rear tail. The fuselage 4 has a substantially vertical plane of symmetry P.

The aircraft 2 further includes a first measuring probe 6A and a second measuring probe 6B. The measuring probes 6A, 6B are so-called multifunction probes.

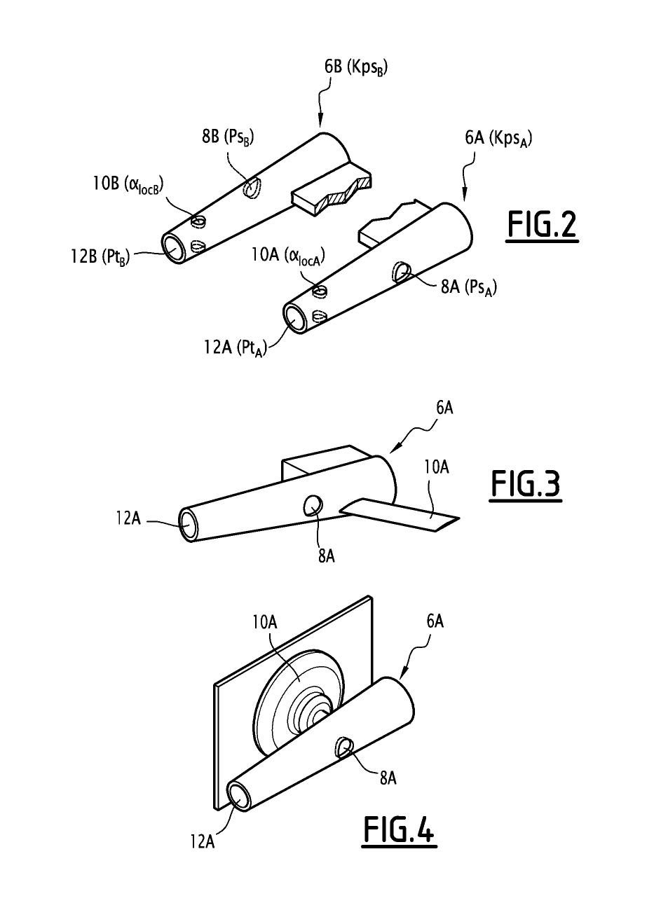

In reference to FIG. 2, the measuring probes 6A, 6B each has means for measuring a static pressure 8A, 8B, respectively, means for measuring the local incidence 10A, 10B, respectively, and means for measuring the total pressure 12A, 12B, respectively. Hereinafter, the letters A and B in the reference and the indices A and B in the parameters respectively refer to the first measuring probe 6A and the second measuring probe 6B.

In the example of FIGS. 1 and 2, each measuring probe 6A, 6B assumes the form of a so-called static Pitot tube extending along the airflow along the fuselage 4. The means for measuring a static pressure 8A, 8B assume the form of one or more orifices positioned on the tube of the measuring probe 6A, 6B, for example on the side of the tube, and oriented substantially parallel to the flow. The means for measuring the total pressure 12A, 12B assume the form of an orifice positioned across from the flow at the end of the tube of the corresponding probe 6A, 6B. The means for measuring the local incidence 10A, 10B are pneumatic and assume the form of two orifices respectively arranged on and under the tube of the measuring probe 6A, 6B, across from each other. It should be noted that for pneumatic means for measuring the local incidence like those of FIG. 2, the determination of a measurement of the local incidence implies knowledge of the static pressure and the total pressure.

Alternatively, in reference to FIG. 3, the means for measuring the local incidence 10A of the measuring probe 6A has a moving paddle 10A aligning in the local bed of the wind and articulated on the tube of the measuring probe.

Alternatively, in reference to FIG. 4, the first measuring probe 6A assumes the form of a static Pitot tube articulated in rotation on a base that is immobile relative to the fuselage. The measurements of the local incidence of the measuring probe 6A are then determined from the orientation of the probe relative to the base, and therefore the fuselage.

Alternatively (not shown), the means for measuring the local incidence 10A, 10B of the measuring probe(s) has an ultrasound device.

Alternatively, one or both measuring probes 6A, 6B assume the form of cone probes, or any other suitable type.

In certain examples, for example in FIGS. 2 and 3, the means for measuring a static pressure 8A, 8B and the means for measuring the total pressure 12A, 12B are immobile relative to the fuselage 4 of the aircraft 2. As a result, the respective pressure coefficients of the measuring probes vary with the local incidence. This is described in more detail below.

In other examples, for example in FIG. 4, one of or the measuring probes 6A, 6B are movably mounted in their entirety on the fuselage 4 and align with the flow of air. Thus, the pressure coefficient of the corresponding measuring probe(s) is a constant function of the local incidence, since the probe is always aligned in the flow of air.

Preferably, the two measuring probes 6A, 6B are identical.

Preferably, the two measuring probes 6A, 6B are positioned symmetrically relative to the plane of symmetry P of the aircraft.

FIG. 5 illustrates the variation of the pressure coefficient of a measuring probe as a function of the incidence of the measuring probe, in the case of a stationary probe, i.e., which is not movably mounted in its entirety on the fuselage.

The measuring probes 6A, 6B, respectively, each have a pressure coefficient denoted Kps_{A}, Kps_{B}, respectively. These pressure coefficients are specific to the corresponding probe and correspond to the pressure disruption created by the corresponding measuring probe 6A, 6B in a flow. These pressure coefficients Kps_{A}, Kps_{B} vary as a function of the incidence of the corresponding measuring probe 6A, 6B along a substantially parabolic curve. Such a curve is illustrated in FIG. 5. FIG. 5 more precisely illustrates the variation of the pressure coefficient Kps of a probe as a function of the incidence of the probe. The incidence of the probe corresponds precisely to the local incidence measured by the probe when the latter is positioned on the aircraft.

The variation curve of each probe pressure coefficient is for example determined by calculation, for example by CFD (Computational Fluid Dynamics), then confirmed by wind tunnel tests.

Furthermore, the pressure coefficients Kps_{A}, Kps_{B} of the measuring probes 6A, 6B are respectively expressed according to the following relationships (1) and (2):

$$\begin{matrix}{Kps}_{A} = \frac{( {Ps}_{A} - {Pi}_{A} )}{( {Pt}_{A} - {Pi}_{A} )} , \\ and & ( 1 ) \\ {Kps}_{B} = \frac{( {Ps}_{B} - {Pi}_{B} )}{( {Pt}_{B} - {Pi}_{B} )} , & ( 2 )\end{matrix}$$

where Ps_{A}, Ps_{B} are respectively the static pressure measurement provided by the measuring probe 6A, 6B, respectively, and Pt_{A}, Pt_{B}, are respectively the total pressure measurement provided by the measuring probe 6A, 6B, respectively. Pi_{A} and Pi_{B} are the static pressures that would be measured at the location of the first measuring probe 6A, the second measuring probe 6B, respectively, in the absence of the corresponding probe. In other words, Pi_{A} and Pi_{B} correspond to the component of the measured static pressure Ps_{A}, Ps_{B} that is independent of the first measuring probe 6A, the second measuring probe 6B, respectively. Hereinafter, Pi will be designated by the expression “independent static pressure” or “independent pressure”.

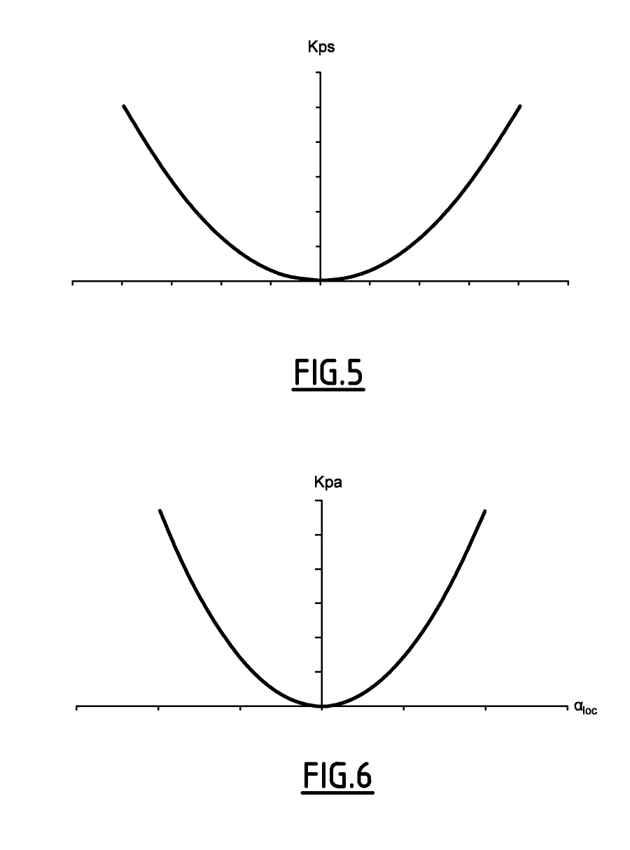

FIG. 6 illustrates, as an example, the variation of the pressure coefficient of the aircraft 2 as a function of the local incidence of the aircraft at constant sideslip.

The pressure coefficient of the aircraft 2 is denoted Kpa hereinafter and corresponds to the pressure disruption created by the aircraft 2 in the flow. The pressure coefficient of the aircraft Kpa is a function of the given local incidence at constant sideslip of the aircraft 2 or at constant incidence of the aircraft 2. In fact, as previously indicated, a given sideslip or incidence value of the aircraft has a corresponding function that associates the pressure coefficient of the aircraft with the local incidence. The corresponding set of curves forms a mesh or grid of parameterized curves at iso-sideslip and iso-incidence.

Each of these functions has a substantially parabolic graph, FIG. 6 illustrating one example of curve variation of the pressure coefficient Kpa as a function of the local incidence α_{loc} for a fixed sideslip value.

Generally, two distinct values of the sideslip or the incidence of the aircraft 2 result in respective variation curves of the pressure coefficient Kpa as a function of the local incidence α_{loc}, those curves being different.

However, the Applicant has observed that most aircraft have at least one zone of their fuselage where the pressure coefficient of the aircraft is a function of the local incidence that is unique irrespective of the sideslip and incidence values of the aircraft. In other words, in that zone, the function that associates the pressure coefficient of the aircraft with the local incidence remains the same when the incidence and/or sideslip of the aircraft vary.

“For all of the sideslip and incidence values of the aircraft” and “irrespective of the sideslip and incidence of the aircraft” refer to all of the sideslip and incidence values corresponding to values of the flight envelope of the corresponding aircraft.

Consequently, in that zone, the pressure coefficient of the aircraft Kpa varies as a function of the local incidence according to a single curve that remains the same when the sideslip β and/or the incidence α of the aircraft 2 vary.

The location of the zone(s) on the fuselage 4 is for example determined by CFD, by which a computer mesh of the aircraft is done and the flow speed is determined at a large quantity of points of the aircraft.

These calculations are done for several values of the sideslip β of the aircraft, for example ten values of the sideslip β, as well as for several values of the incidence α of the aircraft, for example forty values of the incidence of the aircraft. From the obtained results, the location of the zone(s) of the fuselage is deduced where the variations of the aircraft's pressure coefficient as a function of the local incidence follow a single curve irrespective of the values of the incidence α and the sideslip β of the aircraft.

Alternatively, the location of this or these zone(s) is determined in a wind tunnel, or using any other suitable method.

It should be noted that the local incidence α_{loc} itself varies as a function of the incidence α and the sideslip β of the aircraft. However, the measurement of the local incidence α_{loc} does not require the prior determination of the incidence α and/or sideslip β of the considered aircraft.

At least one of the measuring probes 6A, 6B, for example the first measuring probe 6A, is positioned in a first zone 14 of the fuselage 4 in which the pressure coefficient of the aircraft Kpa is a function of the local incidence, which is unique irrespective of the values of the sideslip β and the incidence α of the aircraft. As will be seen later, this makes it possible to determine a value of the upstream infinity static pressure of the aircraft 4, hereinafter denoted P_{∞}, from a single measuring probe, and not from two for the known aircraft.

In practice, it has been observed that the second zone 16, which is symmetrical to the first zone 14 relative to the vertical plane of symmetry P of the fuselage 4, is also a zone in which the pressure coefficient of the aircraft Kpa is a function of the local incidence, which is unique irrespective of the values of the sideslip and incidence of the aircraft.

Consequently, preferably, the second measuring probe 6B is situated in the second zone 16, symmetrical with the first zone 14 relative to the vertical plane of symmetry P. As a result, the second measuring probe 6B makes it possible to obtain a second value of the upstream infinity static pressure of the aircraft 4 directly, without using an additional measuring probe. The determination of the upstream infinity static pressure of the aircraft 4 is described in more detail hereinafter.

It should be noted that furthermore, at each point of the fuselage 4 where there is a static pressure P_{loc} in the absence of a measuring probe, the pressure coefficient of the aircraft Kpa is expressed according to the following relationship (3):

$$Kpa = \frac{( {P}_{loc} - {P}_{∞} )}{( Pt - {P}_{∞} )} , \qquad ( 3 )$$

where Pt is the total pressure at that point.

A method for determining flight parameters, hereinafter referred to as the method, will now be described in reference to FIGS. 1 to 5.

First, during a measuring step 20, at least one first measurement of the local incidence α_{locA} is done, as well as a first measurement of the static pressure Ps_{A}, via the means for measuring the local incidence 10A and the means for measuring a static pressure 8A of the first measuring probe 6A. A first measurement of the total pressure Pt_{A} is also done via the means for measuring the total pressure 12A of the first measuring probe 6A.

Next, during a step for determining flight parameters 22, at least the upstream infinity static pressure of the aircraft P_{∞} is determined.

To that end, the value of the pressure coefficient Kps_{A} of the first measuring probe 6A is determined from the first measurement of the local incidence α_{locA} from the variation curve of the pressure coefficient of the first probe 6A as a function of the local incidence, like that illustrated in FIG. 5. In practice, this variation curve is determined beforehand and recorded.

Next, the independent pressure Pi_{A} is determined with respect to the relationship (1), all of the terms of which are known except the independent pressure Pi_{A}.

The value of the pressure coefficient of the aircraft Kpa is also determined from the first measurement of the local incidence α_{locA} via the variation curve of the pressure coefficient of the aircraft Kpa as a function of the local incidence as illustrated in FIG. 6. This is made possible without prior knowledge of the sideslip or incidence of the aircraft 2 due to the arrangement of the first measuring probe 6A in the first zone 14.

Next, a value of the upstream infinity static pressure of the aircraft P_{∞} is determined from the relationship (3), for which all of the terms are known except P_{∞}:
the local static pressure P_{loc} at the location of the first measuring probe 6A corresponds precisely to the static pressure that would be measured if the first measuring probe 6A was not present, i.e., the independent pressure Pi_{A},
the total pressure Pt is taken to be equal to the first total pressure measurement Pt_{A}, and
the value of Kpa has been previously determined from the local incidence α_{locA} measured by the first probe 6A.

This upstream infinity static pressure of the aircraft P_{∞} is thus determined only from measurements from the first probe 6A. It subsequently makes it possible to determine the other flight parameters required to pilot the aircraft 2. In practice, this determination is also based on the total pressure Pt measured locally, which is constant in the flow.

Alternatively, during the method, a first value of the incidence α of the aircraft 2 and a first value of the sideslip β of the aircraft 2 are also determined.

To that end, during the measuring step 20, the means for measuring the local incidence 10B of the second measuring probe 6B are used to perform a second measurement of the local incidence α_{locB}.

During the step for determining flight parameters 22, the first value of the incidence α and the first value of the sideslip β are determined from the first and second measurements of the local incidence α_{locA} and α_{locB}.

This determination is well known by those skilled in the art and is in particular based on the initial calibration, which results from calculations done by CFD and confirmed by flight tests. The calibration provides, inter alia, the laws between the local incidences α_{locA} and α_{locB} measured via the two measuring probes 6A, 6B and the incidence α, as well as between those local incidences α_{locA} and α_{locB} and the sideslip β.

Also alternatively, during the method, a second value of the sideslip β′ is determined. In this alternative, the second measuring probe 6B is positioned in the second zone 16 symmetrical to the first zone 14 relative to the plane of symmetry P.

To that end, during the measuring step 20, a second measurement of the local incidence α_{locB} is done via the means for measuring the local incidence 10B of the second measuring probe 6B. Furthermore, a second measurement of the total pressure Pt_{B} is done via the means for measuring the total pressure 12B of the second measuring probe 6B.

During the step for determining flight parameters 22, the second value of the sideslip β′ is determined from the independent pressures Pi_{A} and Pi_{B}, a measurement of the total pressure, for example the first measurement of the total pressure Pt_{A}, and the upstream infinity static pressure of the aircraft P_{∞}.

To that end, the independent pressures Pi_{A} and Pi_{B} are determined from variation curves of the pressure coefficient Kps_{A}, Kps_{B} of each of the probes as a function of the local incidence α_{locA}, α_{locB}, respectively, like that illustrated in FIG. 5, as previously described. Next, the second value of the sideslip β′ is determined from the difference between the independent pressures Pi_{A} and Pi_{B} divided by the difference between the total pressure Pt_{A} and the upstream infinity static pressure P_{∞} of the aircraft 2. In other words, the second value of the sideslip β′ is determined from the following quotient:

$$\frac{( {Pi}_{A} - {Pi}_{B} )}{( {Pt}_{A} - {P}_{∞} )}$$

In fact, in a known manner, this quotient is a quasi-linear function of the sideslip of the aircraft 2. This quasi-linear function is also obtained by the initial calibration.

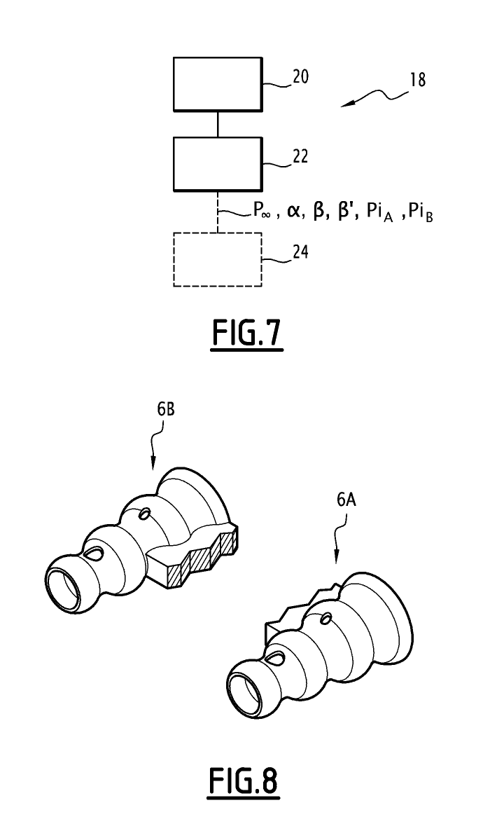

Still in the context of this alternative, the method further includes a validation step 24 (in dotted lines in FIG. 7), during which the first and second values of the sideslip β and β′ are compared, and information on the operating state of the measuring probes 6A, 6B is determined from the results of the comparison.

More specifically, for example, the absolute value of the difference between β and β′ compared to a predetermined threshold, for example 2°, and it is determined that the measuring probes are in good working order if the absolute value of the difference between β and β′ is below that threshold value. Conversely, if the absolute value of that difference is above the threshold value, it is determined that a malfunction exists on one of the probes. This for example leads to an alert message for the pilot and/or the activation of a diagnostic mode of the measuring probes 6A, 6B.

The method according to this alternative of the invention makes it possible to verify the validity of the measurements done from two measuring probes.

Alternatively, in reference to FIG. 8, the first measuring probe 6A has a pressure coefficient Kps_{A} verifying the following relationship (4):

$${Kps}_{A} = \frac{- Kpa}{( 1 - Kpa )} . \qquad ( 4 )$$

Inasmuch as the first measuring probe 6A is positioned in the first zone 14, this relationship is verified for all of the values of the sideslip and the incidence of the aircraft.

By injecting relationships (1) and (3) into relationship (4), we arrive at the following relationship: PS_{A}=P_{∞}. In other words, the static pressure measurement Ps_{A} determined via the first measuring probe 6A corresponds to the upstream infinity static pressure P_{∞} of the aircraft 2. It should be noted that the first measuring probe 6A is then said to be aerodynamically compensated.

In the method according to this alternative, during the step for determining the flight parameters 22, the upstream infinity static pressure of the aircraft P_{∞} is taken to be equal to the first measurement of the static pressure Ps_{A}.

Alternatively, the second measuring probe 6B is positioned in the second zone 16, symmetrical to the first zone 14, relative to the plane of symmetry P, the measuring probes 6A, 6B are identical, and the second measuring probe 6B also verifies relationship (4), i.e.:

$${Kps}_{B} = \frac{- Kpa}{( 1 - Kpa )} .$$

During the method according to this alternative, the upstream infinity static pressure of the aircraft P_{∞} is chosen to be equal to either of the static pressure measurements Ps_{A}, Ps_{B}.

Alternatively, in certain examples in which the second measuring probe 6B is positioned in the second zone 16, which is symmetrical to the first zone 14 relative to the plane of symmetry P, the second measuring probe 6B verifies relationship (4) and the first probe 6A does not verify relationship (4). During the method 18, the upstream infinity static pressure of the aircraft P_{∞} is then chosen to be equal to the measurement of the static pressure provided by the second measuring probe 6B, which verifies relationship (4), i.e., which is aerodynamically compensated.

In practice, the aerodynamic compensation of a probe is done by giving the probe a specific shape, as well as by giving the orifices with which it is provided specific dimensions and locations. This shape, these dimensions and these locations are specific to each aircraft, each aircraft having a unique pressure coefficient. The shape and specificities of the probe are for example determined by CFD, then confirmed in a wind tunnel and/or by flight tests. In the example of FIG. 8, the measuring probe(s) are static Pitot probes whereof the tube has an outer surface with at least one undulation.

As previously indicated, the placement of either of the measuring probes 6A, 6B in a zone 14, 16 in which the pressure coefficient of the aircraft 2 is a function of the unique local incidence irrespective of the values of the sideslip and the incidence of the aircraft results in making it possible to determine the upstream infinity static pressure of the aircraft from a single measuring probe. The corresponding system for measuring flight parameters then has a greatly simplified design.

Furthermore, the use of a measuring probe arranged in this way makes it possible to determine two distinct measurements of the sideslip of the aircraft from two measuring probes instead of three. The validity of the measurements done by the two probes can thus be tested without using a third measuring probe.

The arrangement of the measuring probes 6A, 6B in the first zone 14 for one and the second zone 16, which is symmetrical to the first zone 14 relative to the plane P, makes it possible to achieve two measurements of the upstream infinity static pressure of the aircraft from two probes. This redundancy increases the operating safety and the availability of the corresponding system for measuring flight parameters.

Using an aerodynamically compensated program makes it possible to compensate the pressure disruption caused by the airplane and the probe directly and physically via the probe itself. The upstream infinity static pressure of the aircraft therefore no longer needs to be numerically deduced from other properties.

The immobility of the means for measuring the static pressure and means for measuring the total pressure of the measuring probes 6A, 6B relative to the fuselage 4 results in causing the pressure coefficient of the probe Kps to vary with the local incidence.

Conversely, the fact that the measuring probe(s) are mounted entirely movably results in making the pressure coefficient of the corresponding probe(s) a constant function of the local incidence.

As a result, in the examples in which the measuring probes 6A, 6B are identical and movably mounted and in which a second value of the sideslip β′ of the aircraft 2 is determined, that determination is simplified: in fact, the pressure disruptions are the same for both measuring probes 6A, 6B, such that the second sideslip value β′ is determined directly from the difference between the static pressures PsA and PsB, rather than by the difference between the independent pressures Pi_{A} and Pi_{B}. This difference is always divided by the difference between the measurement of the total pressure and the upstream infinity static pressure of the aircraft P_{∞}.

Also alternatively, one or both measuring probes 6A, 6B do not include means for measuring the total pressure 12A, 12B. In these examples, the means for measuring the local incidence 10A, 10B of the corresponding measuring probe(s) are not pneumatic measuring means. Furthermore, the aircraft includes means for measuring the total pressure providing the total pressure measurements required to implement the method.

Preferably, the values of the different parameters associated with a given measuring probe are determined from measurements done by the corresponding measuring probe. For example, in the examples previously described, the pressure coefficient Kpsa of the first measuring probe 6A is determined from the static pressure Ps_{A}, the local incidence α_{locA}, and the total pressure Pt_{A} provided by the first measuring probe 6A.

However, in certain examples, the value of different parameters associated with the measuring probe is determined from one or more measurements done by the other measuring probe.

In other examples, the examples previously described and that are technically compatible with each other are combined.

1. An aircraft comprising:
a fuselage; and
a first measuring probe comprising:
an incidence device measuring the local incidence,
a pressure device measuring the static pressure, and
a total pressure device measuring the total pressure, wherein the fuselage includes at least one first zone where the pressure coefficient of the aircraft depends on the local incidence, which is unique irrespective of the sideslip and incidence values of the aircraft, and
wherein the first measuring probe is arranged in said first zone.

2. The aircraft according to claim 1, further comprising a second measuring probe comprising:
a secondary incidence device measuring the local incidence,
a secondary pressure device measuring the static pressure, and
a secondary total pressure device measuring the total pressure.

3. The aircraft according to claim 2, wherein the second measuring probe is arranged on the fuselage in a second zone symmetrical with the first zone relative to a vertical plane of symmetry of the aircraft.

4. The aircraft according to claim 1, wherein the pressure device and the total pressure device are immobile relative to the fuselage of the aircraft.

5. The aircraft according to claim 1, wherein the first measuring probe has a pressure coefficient verifying the relationship:
$$Kps = \frac{- Kpa}{( 1 - Kpa )} ,$$
where Kps is the pressure coefficient of said measuring probe and Kpa is the pressure coefficient of the aircraft.

6. A method for determining flight parameters of an aircraft comprising a fuselage and a first measuring probe comprising an incidence device measuring the local incidence, a pressure device measuring the static pressure, and a total pressure device measuring the total pressure, wherein the fuselage includes at least one first zone where the pressure coefficient of the aircraft depends on the local incidence, which is unique irrespective of the sideslip and incidence values of the aircraft, and wherein the first measuring probe is arranged in said first zone, comprising a step of taking at least one first measurement of the static pressure and one first measurement of the local incidence via the first measuring probe.

7. The method according to claim 6 for determining flight parameters of an aircraft, further comprising the step of equating the upstream infinity static pressure of the aircraft to the static pressure measured via the first measuring probe whereof the pressure coefficient verifies the relationship:
$$Kps = \frac{- Kpa}{( 1 - Kpa )} .$$

8. The method according to claim 7 for determining flight parameters of the aircraft further comprising a second measuring probe comprising a secondary incidence device measuring the local incidence, a secondary pressure device measuring the static pressure, and a secondary total pressure device measuring the total pressure, further comprising the step of, determining a second value of the sideslip of the aircraft from the first measurement of the static pressure and a measurement of the static pressure done via the second measuring probe, a measurement of the total pressure and the value of the upstream infinity static pressure of the aircraft.

9. The method according to claim 6, further comprising the step determining flight parameters during which at least one value of the upstream infinity static pressure of the aircraft is determined.

10. The method according to claim 9 for determining flight parameters of the aircraft further comprising a second measuring probe comprising a secondary incidence device measuring the local incidence, a secondary pressure device measuring the static pressure, and a secondary total pressure device measuring the total pressure, wherein during the measuring step, a second measurement of the local incidence is also done via the second measuring probe, and wherein during the step for determining flight parameters, a first value of the sideslip and a first value of the incidence of the aircraft are determined from first and second measurements of the local incidence.

11. The method according to claim 9, wherein during the step for determining flight parameters further comprises the step of determining the value of the pressure coefficient of the first measuring probe and the value of the pressure coefficient of the aircraft from the first local incidence measurement.

12. The method according to claim 11, wherein a measurement of the total pressure is also done during the measuring step,
wherein during the step for determining flight parameters,
determining a value of an independent static pressure associated with the first measuring probe from the pressure coefficient of the first measuring probe, the first static pressure measurement and the total pressure measurement, and
determining the value of the upstream infinity static pressure of the aircraft from the pressure coefficient of the aircraft, the total pressure measurements and said independent static pressure.

13. The method according to claim 12 for determining flight parameters of an aircraft further comprising a second measuring probe comprising a secondary incidence device measuring the local incidence, a secondary pressure device measuring the static pressure, and a secondary total pressure device measuring the total pressure, wherein during the step for determining flight parameters, determining a second value of the sideslip of the aircraft from the first measurement of the static pressure and a measurement of the static pressure done via the second measuring probe, a measurement of the total pressure and the value of the upstream infinity static pressure of the aircraft.

14. The method according to claim 13 for determining flight parameters of an aircraft, wherein during the measuring step, a second measurement of the local incidence is also done via the second measuring probe, and wherein during the step for determining flight parameters, determining a first value of the sideslip and a first value of the incidence of the aircraft from first and second measurements of the local incidence and
wherein the method further comprises a validation step, during which the first and second values of the sideslip of the aircraft are compared.

15. The method according to claim 9 for determining flight parameters of an aircraft, further comprising the step of equating the upstream infinity static pressure of the aircraft to the static pressure measured via the or one of the measuring probes whereof the pressure coefficient verifies the relationship:
$$Kps = \frac{- Kpa}{( 1 - Kpa )} .$$

16. The method according to claim 15 for determining flight parameters of an aircraft further comprising a second measuring probe comprising a secondary incidence device measuring the local incidence, a secondary pressure device measuring the static pressure, and a secondary total pressure device measuring the total pressure, wherein during the step for determining flight parameters, determining a second value of the sideslip of the aircraft from the first measurement of the static pressure and a measurement of the static pressure done via the second measuring probe, a measurement of the total pressure and the value of the upstream infinity static pressure of the aircraft.

17. The method according to claim 16 for determining flight parameters of an aircraft, wherein during the measuring step, performing a second measurement of the local incidence via the second measuring probe, and
wherein during the step for determining flight parameters, determining a first value of the sideslip and a first value of the incidence of the aircraft from first and second measurements of the local incidence and
wherein the method further comprises a validation step, comparing the first and second values of the sideslip of the aircraft.
